(19) United States
(12) Patent Application Publication
(10) Pub. No.: US 2026/0059543 A1
(43) Pub. Date: Feb. 26, 2026

(54) Method of Performing a Control Channel Decoding, a Computer Program Product, a Non-transitory Computer-Readable Storage Medium, a Processing Unit, and a Chip Therefor

(71) Applicant: BEAMMWAVE AB, Lund (SE)

(72) Inventors: Joakim Axmon, Limhamn (SE); Bengt Lindoff, Bjärred (SE)

(21) Appl. No.: 19/105,723

(22) PCT Filed: Sep. 7, 2023
(86) PCT No.: PCT/SE2023/050881

§ 371 Date: Feb. 21, 2025

(30) Foreign Application Priority Data
Sep. 9, 2022 (SE) 2230282-2

(51) Int. Cl. H04W 72/232; H04L 25/02

(52) U.S. Cl. CPC H04W 72/232; H04L 25/0202

(57) ABSTRACT

A method of performing a control channel decoding, for a processing unit, wherein the processing unit is comprisable in a wireless device, WD, the WD comprising a transceiver and a memory connectable to the processing unit (600), the method comprising: receiving, at the WD, via the transceiver a first number of control channel elements, CCEs, each CCE comprising a second number of Resource Element Groups, REGs, the first number of CCEs comprising a first and a second set of radio resources, wherein the first set of radio resources comprises known reference symbols of the first number of CCEs, and wherein the second set of radio resources comprises downlink control information, DCI, of the first number of CCEs; storing the second set of radio resources in the memory

### TECHNICAL FIELD

The present disclosure relates to a method of performing a control channel decoding, a computer program product, a non-transitory computer-readable storage medium, a processing unit, and chips.

More specifically, the disclosure relates to a method of performing a control channel decoding, a computer program product, a non-transitory computer-readable storage medium, a processing unit, and chips as defined in the introductory parts of the independent claims.

### BACKGROUND ART

In 5G New Radio (5G-NR) a wireless device (WD) is only forced to look for scheduling messages in one bandwidth part at a time. Within this bandwidth part the WD is configured to monitor one or several control resource sets (CORESETs). Thus, in 5G-NR each WD is configured with a set of control resource sets, CORESETs. Each CORESET may comprise downlink control information (DCI) allocated for a specific WD (or DCI allocated for multiple WDs, comprising e.g., paging information, system information, and/or similar multicasts/broadcasts over a Physical Data Shared Channel). However, since each CORESET only specify the possible locations where the gNodeB (gNB) can put signalling messages, the CORESET may be larger than the DCI and/or the DCI may not be present in all CORESETs. Thus, the DCI may be smaller than the CORESET or not present in the CORESET and hence the WD will have to perform a search over the CORESET to determine whether the CORESET or a particular subset of the CORESET comprises DCI.

In order to decode a DCI, each CORESET comprises reference signals (RS), e.g., demodulation reference signals/symbols (DM-RS). Some CORESETs are dedicated to the WD (or associated with the WD) and these CORESETs comprises specific DM-RSs associated with the WD (whereas other WDs are associated with other DM-RSs).

Furthermore, control channel decoding may be a power consuming task since the WD needs to perform control channel decoding for each downlink (DL) slot configured for possible control channel, even if the number of actual control channel allocation may be in the range of few percent of the time.

Hence there may be a need for a method (and/or an apparatus) with an improved control channel decoding procedure.

EP 3858027 A1 discloses monitoring and decoding of Physical Downlink Control Channel (PDCCH). However, such control channel decoding may need to be improved.

Furthermore, US 2022/0014397 A1 discloses that a scheduled entity measures a power level of a demodulation reference signal (DMRS) prior to blind decoding a physical downlink control channel (PDCCH) candidate associated with the DMRS. The scheduled entity performs blind decoding of the PDCCH candidate if the power level is above a predetermined threshold or foregoes blind decoding if the power level is below the predetermined threshold. However, in US 2022/0014397 A1 the decoding is performed for only the PDCCH candidate associated with one particular DMRS at the time, i.e., each DMRS needs to be checked separately. Thus, there is a need for improved/increased capacity of a wireless communication system, reduced power consumption for reception and/or transmission of data, improved/increased robustness (of the communication), improved or optimized downlink performance, reduced complexity, and/or simplified implementation.

### SUMMARY

An object of the present disclosure is to mitigate, alleviate or eliminate one or more of the above-identified deficiencies and disadvantages in the prior art and solve at least the above-mentioned problem.

According to a first aspect there is provided a method of performing a control channel decoding, for a processing unit, such as a baseband (BB) processor, the processing unit comprisable in a wireless device (WD), the WD comprising a transceiver and a memory connectable to the processing unit, the method comprising: receiving, at the WD, via the transceiver, a first number of control channel elements, CCEs, each CCE comprising a second number of Resource Element Groups, REGs, and the first number of CCEs comprising a first and a second set of radio resources, wherein the first set of radio resources comprises known reference symbols of the first number of CCEs, and wherein the second set of radio resources comprises downlink control information, DCI of the first number of CCEs; storing the second set in the memory; obtaining one or more channel estimates for a third number of REGs based on the first set of radio resources; determining a signal quality value for each of the one or more obtained channel estimates; comparing the one or more determined signal quality values to a quality threshold function; obtaining a number of determined signal quality values being equal to or above the quality threshold function; if the obtained number of determined signal quality values is below a pre-determined number, discarding the second set of radio resources from the memory; and if the obtained number of determined signal quality values is equal to or above the pre-determined number, retrieving the second set of radio resources from the memory and performing a control channel decoding of the second set of radio resources.

According to some embodiments, the third number is equal to the second number.

According to some embodiments, the third number is lower than the second number.

According to some embodiments, the third number is larger than the second number.

According to some embodiments, the first set of radio resources comprises all known reference symbols comprised by the first number of CCEs, and wherein the second set of radio resources comprises all DCI comprised by the first number of CCEs.

According to some embodiments, the first set of radio resources comprises known reference symbols, such as demodulation reference symbols (DM-RS), and the second set of radio resources comprises downlink control information (DCI).

According to some embodiments, performing a control channel decoding of the second set of radio resources comprises performing a search for DCI in the second set of radio resources.

According to some embodiments, obtaining one or more channel estimates comprises correlating the first set of radio resources and individually known reference symbols to obtain one or more correlation metrics.

According to some embodiments, the quality threshold function is determined based on one or more obtained signal to noise ratio, SNR, values associated with a radio signal quality.

According to some embodiments, the quality threshold function is determined based on one or more reference signals, such as one or more synchronization signal blocks (SSBs), one or more Channel State Information Reference Signals (CSI-RSs), or demodulation reference signals (DM-RSs), retrieved from a successfully decoded DCI or from reference signals, such as demodulation reference signals (DM-RSs), associated with a data channel, such as a Physical Data Shared Channel (PDSCH).

According to some embodiments, the first and second sets of radio resources are received at time instants configured for control resource set (CORESET) monitoring.

According to a second aspect there is provided a program product comprising instructions, which, when executed on at least one processor of a processing device, cause the processing device to carry out the method according to the first aspect or any of the embodiments mentioned herein.

According to a third aspect there is provided a non-transitory computer-readable storage medium storing one or more programs configured to be executed by one or more processors of a processing device, the one or more programs comprising instructions which, when executed by the processing device, causes the processing device to carry out the method according to the first aspect or any of the embodiments mentioned herein.

According to a fourth aspect there is provided a processing unit, such as a baseband (BB) processor, wherein the processing unit is comprisable in a wireless device (WD), the WD comprising a transceiver and a memory connectable to the processing unit, the processing unit comprising controlling circuitry configured to cause: reception, via the transceiver, of a first number of control channel elements, CCEs, each CCE comprising a second number of Resource Element Groups, REGs, and the first number of CCEs comprising a first and a second set of radio resources, wherein the first set of radio resources comprises known reference symbols of the first number of CCEs, and wherein the second set of radio resources comprises downlink control information, DCI of the first number of CCEs; a first and a second set of radio resources via the transceiver; storage of the second set in the memory; obtainment of one or more channel estimates for a third number of REGs based on the first set of radio resources; determination of a signal quality value for each of the one or more obtained channel estimates; comparison of the one or more determined signal quality values to a quality threshold function; obtainment of a number of determined signal quality values being equal or above the quality threshold function; if the obtained number of determined signal quality values is below a pre-determined number, discarding of the second set of radio resources from the memory; and if the obtained number of determined signal quality values is equal to or above the pre-determined number, retrieval of the second set of radio resources from the memory and performance of a control channel decoding of the second set of radio resources.

According to some embodiments, the processing unit is comprisable or comprised in a wireless device, WD, wherein the processing unit comprises a channel estimation unit and a control channel decoding unit, and the processing unit is connected or connectable to the transceiver, and the memory.

According to some embodiments, the third number is equal to the second number.

According to some embodiments, the third number is lower than the second number.

According to some embodiments, the third number is larger than the second number.

According to some embodiments, the first set of radio resources comprises all known reference symbols comprised by the first number of CCEs, and wherein the second set of radio resources comprises all DCI comprised by the first number of CCEs.

According to a fifth aspect there is provided a chip. The chip comprises the processing unit of the third aspect.

Effects and features of the second, third, fourth, and fifth aspects are fully or to a large extent analogous to those described above in connection with the first aspect and vice versa. Embodiments mentioned in relation to the first aspect are fully or largely compatible with the second, third, fourth, and fifth aspects and vice versa.

An advantage of some embodiments is that the capacity of a wireless communication system is improved/increased (e.g., optimized).

Another advantage of some embodiments is a reduced power consumption for reception and/or transmission of data.

Yet another advantage of some embodiments is that robustness (of the communication) is improved/increased.

A further advantage of some embodiments is that performance, e.g., downlink performance, is improved or optimized.

Yet a further advantage of some embodiments is that complexity is reduced (or minimized).

Yet another further advantage of some embodiments is that implementation is simplified.

Yet a further another advantage of some embodiments is that control channel decoding is improved, made faster and/or optimized.

The present disclosure will become apparent from the detailed description given below. The detailed description and specific examples disclose preferred embodiments of the disclosure by way of illustration only. Those skilled in the art understand from guidance in the detailed description that changes, and modifications may be made within the scope of the disclosure.

Hence, it is to be understood that the herein disclosed disclosure is not limited to the particular component parts of the device described or steps of the methods described since such apparatus and method may vary. It is also to be understood that the terminology used herein is for purpose of describing particular embodiments only and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps. Furthermore, the term “configured” or “adapted” is intended to mean that a unit or similar is shaped, sized, connected, connectable, programmed or otherwise adjusted for a purpose.

As used herein, the term “if” may be construed to mean “when or “upon” or “in response to” depending on the context. Similarly, the phrase “if it is determined′ or “when it is determined” or “in an instance of” may be construed to mean “upon determining or “in response to determining” or “upon detecting and identifying occurrence of an event” or “in response to detecting occurrence of an event” depending on the context. Accordingly, the phrase “if X equals Y” may be construed as “when X equals Y”, “when it is determined that X equals Y”, “in response to X being equal to Y”, or “in response to detecting/determining that X equals Y” depending on the context.

### BRIEF DESCRIPTIONS OF THE DRAWINGS

The above objects, as well as additional objects, features, and advantages of the present disclosure, will be more fully appreciated by reference to the following illustrative and non-limiting detailed description of example embodiments of the present disclosure, when taken in conjunction with the accompanying drawings.

FIG. 1A is a schematic drawing illustrating method steps according to some embodiments;

FIG. 1B is a schematic drawing illustrating a wireless device comprising a processor according to some embodiments;

FIG. 2 is a flowchart illustrating method steps implemented in a processing unit, such as a baseband (BB) processor, in a wireless device comprising the processing unit or in a control unit/control circuitry thereof, according to some embodiments;

FIG. 3 is a schematic drawing illustrating a computer readable medium according to some embodiments;

FIG. 4 is a schematic drawing illustrating a Resource Element Group (REG) according to some embodiments;

FIG. 5 is a schematic drawing illustrating a control channel element (CCE) according to some embodiments;

FIG. 6 is a schematic drawing illustrating an aggregation that constitutes the PDCCH according to some embodiments;

FIG. 7 is a schematic drawing illustrating two examples of a CORESET laid out in a slot according to some embodiments;

FIG. 8 is a schematic drawing illustrating possible positions for a PDCCH in a CORESET according to some embodiments;

FIG. 9 is a schematic drawing illustrating how to estimate metrics of demodulation reference signal(s) (DM-RS) over a number of sub-bands according to some embodiments; and

FIG. 10 is a schematic drawing illustrating an example of PDCCH which has been transmitted/received according to some embodiments.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

### Terminology

Below is referred to a wireless device (WD). A wireless device is any device capable of transmitting or receiving signals wirelessly. Some examples of wireless devices are user equipment (UE), mobile phones, cell phones, smart phones, Internet of Things (IoT) devices, vehicle-to-everything (V2X) devices, vehicle-to-infrastructure (V2I) devices, vehicle-to-network (V2N) devices, vehicle-to-vehicle (V2V) devices, vehicle-to-pedestrian (V2P) devices, vehicle-to-device (V2D) devices, vehicle-to-grid (V2G) devices, fixed wireless access (FWA) points, tablets, laptops, wireless stations, relays, repeater devices, reconfigurable intelligent surfaces, and large intelligent surfaces.

Below is referred to a “transceiver node” (TNode). A TNode may be a radio unit (RRU), a repeater, a wireless node, or a base station (BS), such as a radio base station (RBS), a Node B, an Evolved Node B (eNB) or a gNodeB (gNB). Furthermore, a TNode may be a BS for a neighbouring cell, a BS for a handover (HO) candidate cell, a radio unit (RRU), a distributed unit (DU), another WD (e.g., a remote WD) or a base station (BS) for a (active/deactivated) secondary cell (SCell) or for a serving/primary cell (PCell, e.g., associated with an active TCI state), a laptop, a wireless station, a relay, a repeater device, a reconfigurable intelligent surface, or a large intelligent surface.

Herein is referred to millimetre Wave (mmW) utilization, mmW communication, mmW communication capability and mmW frequency range. The mmW frequency range is from 24.25 Gigahertz (GHz) to 71 GHz or more generally from 24 to 300 GHz. mmW may also be referred to as Frequency Range 2 (FR2).

Below is referred to a processing unit. The processing unit may be a digital processor. Alternatively, the processor may be a microprocessor, a microcontroller, a central processing unit, a co-processor, a graphics processing unit, a digital signal processor, an image signal processor, a quantum processing unit, or an analog signal processor. The processing unit may comprise one or more processors and optionally other units, such as a control unit.

Below is referred to a digital interface. A digital interface is a unit converting analog signals from e.g., transceivers to digital signals, which digital signals are conveyed to e.g., a baseband processor or other processing unit, and/or converting digital signals from e.g., a baseband processor to analog signals, which analog signals are conveyed to e.g., one or more transceivers. A digital interface possible also comprises filters and other pre-processing functions/units.

Below is referred to an antenna unit. An antenna unit may be one single antenna. However, an antenna unit may also be a dual antenna, such as a dual patch antenna with a first (e.g., horizontal) and a second (e.g., vertical) polarization, thus functioning as two separate antennas or an antenna unit having two ports.

Herein is referred to a “filter”. A filter is a device or process that removes some features, components, or frequencies from a signal.

Herein is referred to “analog beamforming”, “hybrid beamforming” and “digital beamforming”. Digital beamforming means that the beamforming processing, e.g., multiplication of a coefficient, is performed before digital to analog conversion (DAC) for transmission (and after analog to digital conversion, ADC, for reception), i.e., in the digital domain. Analog beamforming means that the beamforming processing, e.g., phase shifting, is performed after DAC for transmission (and before ADC for reception), i.e., in the analog domain. Hybrid beamforming means that some beamforming processing, e.g., phase shifting, is performed after DAC and some beamforming processing, e.g., multiplication of a coefficient, is performed before DAC for transmission (and before and after ADC for reception), i.e., processing in both digital and analog domains.

### Basic Concept

5G-NR specifies that the demodulation reference signals (DM-RSs) associated with the wireless devices (WDs) must be transmitted in slots having downlink control information (DCI) associated with/allocated to the WDs. This is especially the case for CORESETs dedicated only to one WD (i.e., WD specific CORESETs). Hence, in case there is no DM-RS present in a downlink (DL) slot with a WD specific CORESET there may be no DCI allocated to the WD. Hence this information can be utilized for detecting a need for searching for the DCI in the WD specific CORESET (and a need for decoding the DCI). If there is no need for a search of DCI in the WD specific CORESET, the CORESET may be discarded, and no search will be performed. A basic concept of the invention is that the WD, e.g., at time instants configured for CORESET monitoring, receives radio resources via a transceiver, stores at least some of the radio resources in a memory associated with a processing unit, such as a baseband (BB) processor. The processing unit then retrieves or directly checks radio resources allocated to DM-RS and a channel estimation unit estimates the radio channel and determines the signal quality for the channel estimate(s). Upon determination that signal quality is below a threshold, the stored radio resources, e.g., the CORESET, is discarded from the memory and decoding is not performed. Upon detection that signal quality is higher than a threshold, the radio resources allocated to the control channel information is retrieved from the memory and control channel decoding is performed in a control channel decoding unit in the processing unit. In some embodiments, the threshold is determined based on a current received signal quality for the received radio signal. Such signal quality may be determined from other reference symbols (e.g., synchronization signal blocks, SSBs, Channel State Information Reference Signals, CSI-RSs) or determined from DM-RSs from the control channel once it is determined that the DM-RSs have been transmitted (i.e., after a successful decoding) or determined from transmitted DM-RSs associated with a data channel, such as a physical downlink shared channel (PDSCH).

### Embodiments

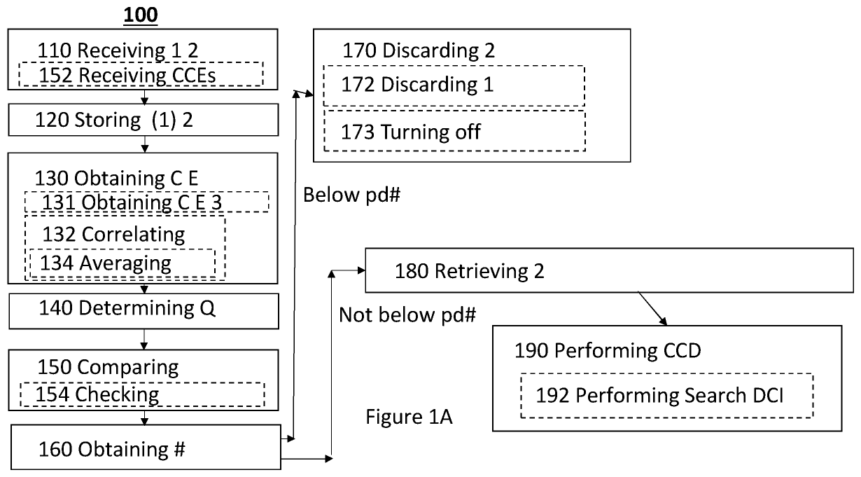

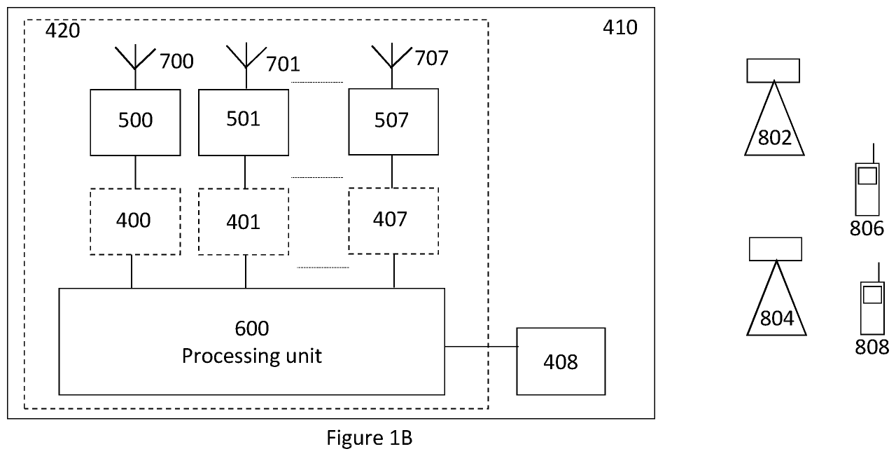

In the following, embodiments will be described where FIG. 1A illustrates method steps according to some embodiments and FIG. 1B illustrates a wireless device 410 comprising a processor 600 according to some embodiments. The method 100 is a method of performing control channel decoding. Furthermore, the method 100 is for a processor 600, such as a baseband (BB) processor. The processor 600 is comprisable or comprised in the wireless device (WD) 410. The WD 410 comprises one or more transceivers 500, 501, . . . , 507. In some embodiments, the one or more transceivers 500, 501, . . . , 507 are radio transceivers. Furthermore, the WD 410 comprises one or more antenna units 700, 701, . . . , 707. Each antenna unit 700, 701, . . . , 707 is connectable or connected to a respective/corresponding transceiver 500, 501, . . . , 507. Moreover, the processing unit 600 is connected or connectable to one or more transceivers 500, . . . , 507 directly or via one or more digital interfaces 400, 401, . . . , 407. In some embodiments, a multi-antenna transmitter and receiver arrangement (MATARA) 420 comprises the transceivers 500, 501, . . . , 507, the processing unit 600 and optionally the digital interfaces 400, . . . , 407 and/or the one or more antenna units 700, 701, . . . , 707. The WD 410 comprises a memory 408 connectable or connected to the processor 600. The memory 408 may be internal or external to the processor. The method 100 comprises receiving 110 a first and a second set of radio resources via the transceiver 500 or via one or more transceivers 500, 501, . . . , 507 (and associated antenna units 700, 701, . . . , 707). In some embodiments, the first set of radio resources comprises known reference symbols, such as demodulation reference symbols/signals (DM-RSs) and the second set of radio resources comprises downlink control information (DCI). I.e., in some embodiments, the first set of radio resources is allocated to individually known reference symbols/signals, such as DM-RSs, and the second set of radio resources is allocated for (possible) DCI. In some embodiments, the first and second sets of radio resources are received at time instants configured for control resource set (CORESET) monitoring. In some embodiments, a CORESET comprises the first and second sets of radio resources. Furthermore, in some embodiments, receiving 110 comprises receiving 152, at the WD 410, a first number of control channel elements (CCEs) via the transceiver (500). Each CCE comprises a second number of Resource Element Groups (REGs). Furthermore, the first number of CCEs comprise a/the first and a/the second set of radio resources. Moreover, the first set of radio resources comprises, e.g., all, known reference symbols of/comprised in the first number of CCEs, and the second set of radio resources comprises, e.g., all, downlink control information (DCI) of/comprised in the first number of CCEs. Furthermore, the method 100 comprises storing 120 the second set of radio resources in the memory 408. In some embodiments, also the first set of radio resources is stored in the memory 408, e.g., storing 120 the second set of radio resources comprises storing the first set of radio resources in the memory 408. In these embodiments, the first set of radio resources is retrieved from the memory 408 in order to obtain the one or more channel estimates (i.e., before obtaining 130 channel estimates). However, in some embodiments, the channel estimation (obtaining 130 channel estimates) is performed directly without storing the first set of radio resources in the memory 408. Moreover, the method 100 comprises obtaining 130 one or more channel estimates, e.g., for a third number of REGs, based on the first set of radio resources. In some embodiments, the third number is equal to the second number. Alternatively, the third number is larger/greater than the second number. As another alternative, the third number is smaller/lower than the second number. In some embodiments, obtaining 130 one or more channel estimates comprises correlating 132 the first set of radio resources and/with individually known reference symbols/signals to obtain one or more correlation metrics. As an example, the Pearson product-moment correlation coefficient (PPMCC) may be calculated, e.g., as the ratio of the covariance of the first set of radio resources and the individually known reference symbols/signals normalized to the square root of their variances. In some embodiments, the correlating 132 comprises averaging 134 over a number of pilots/reference symbols/reference signals, e.g., over the previous, the current and the following reference symbols (for each reference symbol). Alternatively, the correlating 132 comprises no averaging. The individually known reference symbols/signals may be reference symbols/signals, such as DM-RSs, associated with the WD 410. The one or more channel estimates is, in these embodiments, based on the one or more correlation metrics obtained. As an example, the one or more channel estimates are directly obtained from the one or more correlation metrics, e.g., each of the one or more channel estimates are directly obtained as a corresponding correlation metric. The method 100 comprises determining 140 one or more signal quality values for the one or more obtained channel estimates, e.g., determining a (corresponding) signal quality value for each of the one or more obtained channel estimates. The one or more signal quality values may be determined as one or more Reference Signal Received Power (RSRP) values, one or more Reference Signal Received Quality (RSRQ) values or one or more Signal to Interference & Noise Ratio (SINR) values. Furthermore, the method 100 comprises comparing 150 the one or more determined signal quality values to a quality threshold function. In some embodiments, the quality threshold function is determined based on one or more obtained signal to noise ratio (SNR) values associated with a radio signal quality (of the radio signal received via the transceiver 700, i.e., of the radio channel between the WD 410 and a TNode/gNB). Additionally, or alternatively, the quality threshold function is determined based on one or more reference signals, such as one or more synchronization signal blocks (SSBs), one or more Channel State Information Reference Signals (CSI-RSs), or demodulation reference signals (DM-RSs), retrieved from a successfully decoded DCI. As another alternative, or in addition, the quality threshold function is determined based on reference signals, such as demodulation reference signals (DM-RSs), associated with a data channel, such as a Physical Data Shared Channel (PDSCH). The quality threshold function comprises a corresponding value for each of the determined signal quality values. In some embodiments, the quality threshold function is a constant, and thus all the values of the function are the same, i.e., all the values of the function are equal to the constant (value). Thus, in some embodiments, the method 100 comprises comparing (150) the one or more determined signal quality values to a constant. Moreover, the method 100 comprises obtaining 160 a number of determined signal quality values being equal to or above the quality threshold function. The method 100 comprises discarding 170 the second set of radio resources from the memory 408 (e.g., without performing a search for DCI in the second set of radio resources), if the obtained number of determined signal quality values is below a pre-determined number. In some embodiments, the method 100 comprises discarding 172 the first set of radio resources from the memory 408 (e.g., if the first set of radio resources was stored in the memory 408) if the obtained number of determined signal quality values is below a pre-determined number. Furthermore, in some embodiments, the method 100 comprising turning off 173, e.g., by a control unit or by the processor 600, one or more transceivers 500, 501, . . . , 507, e.g., the transceiver 500, and keep the one or more transceivers 500, 501, . . . , 507, e.g., the transceiver 500, turned off until a specified time instant (and turn on the one or more transceivers 500, 501, . . . , 507 at the specified time instant) if the obtained number of determined signal quality values is below a pre-determined number. In some embodiments, the specified time instant is the next time instant the WD needs to receive radio signals, such as synchronization signals or pilot signals, for Channel state information (CSI) estimation or for Radio resource management (RRM) measurements, i.e., the next/following time instant configured for reception of radio signals related to CSI estimation or RRM measurements. Alternatively, the specified time instant is the next time the WD needs to monitor for CORESETs, i.e., the next/following time instant configured for CORESET monitoring. Thus, the one or more transceivers 500, 501, . . . , 507 may be put to micro-sleep (for a period of time). A power consumption reduction may thus be achieved. Alternatively, the one or more transceivers 500, 501, . . . , 507 are left on. Thus, no on/off control of the one or more transceivers 500, 501, . . . , 507 is needed (although no power consumption reduction is achieved).

The method 100 comprises retrieving 180 the second set of radio resources from the memory 408 if the obtained number of determined signal quality values is equal to or above the pre-determined number. Moreover, the method 100 comprises performing 190 a control channel decoding (or decoding a control channel) of the second set of radio resources if the obtained number of determined signal quality values is equal to or above the pre-determined number. In some embodiments, performing 190 a control channel decoding of the second set of radio resources comprises performing 192 a search for DCI in the second set of radio resources (searching for DCI in the second set of radio resources). In some embodiments, the method 100 comprising turning off, e.g., by a control unit or by the processor 600, one or more transceivers 500, 501, . . . , 507, and keep the one or more transceivers 500, 501, . . . , 507 turned off until next time the WD needs to monitor for CORESETs, i.e., until the next/following time instant configured for CORESET monitoring (and thus turning the one or more transceivers 500, 501, . . . , 507 on at the next/following time instant configured for CORESET monitoring) after the control channel decoding has been performed. Thus, a power consumption reduction may be achieved. Alternatively, the one or more transceivers 500, 501, . . . , 507 are left on. Thus, no on/off control of the one or more transceivers 500, 501, . . . , 507 is needed (although no power consumption reduction is achieved).

Furthermore, in some embodiments, one or more of the steps receiving 110, storing 120, obtaining channel estimates 130, correlating 132, averaging 134, determining 140, comparing 150, obtaining a number of determined signal quality values being equal to or above the quality threshold function 160, discarding second set 170, discarding first set 172, turning off 173, retrieving 180, performing control channel decoding 190 and performing a search for DCI 192 are repeated. As an example, after step 170 or step 190 the method starts over again with the step 110 e.g., at the next/following time instant configured for CORESET monitoring, at which time instant the one or more transceivers 500, 501, . . . , 507 may be turned on.

FIG. 1B illustrates a wireless device (WD) 410 according to some embodiments. In some embodiments, the WD 410 comprises a multi-antenna transmitter and receiver arrangement (MATARA) 420. The WD 410 (and/or the MATARA 420) comprises a processing unit 600, such as a baseband processor, a control unit or similar controlling circuitry. Furthermore, the processing unit 600 is connected or connectable to a plurality of transceivers 500, . . . , 507 directly or via one or more digital interfaces 400, . . . , 407. Moreover, in some embodiments, each transceiver 500, . . . , 507 is connected to one or more antenna units 700, . . . , 707. In some embodiments, the WD 410 and/or the MATARA 420 comprises the transceivers 500, . . . , 507, the processing unit 600 and optionally the digital interfaces 400, . . . , 407 and/or the one or more antenna units 700, . . . , 707. Alternatively, in some embodiments, the MATARA 420 comprises the transceivers 500, . . . , 507, and optionally the digital interfaces 400, . . . , 407 and/or the one or more antenna units 700, . . . , 707 and the WD 410 comprises the processing unit 600. In some embodiments, the digital interfaces 400, . . . , 407 are comprised in a respective transceiver 500, . . . , 507. In some embodiments, the digital interfaces 400, . . . , 407 are comprised in the processing unit 600. The WD 410 comprises one or more memories 408 connectable or connected to the processor 600. Furthermore, the WD 410 is able/configurable/configured to communicate with (transmit to and/or receive from) one or more of remote transceiver nodes (TNodes) 802, 804, 806, 808 (via antenna units 700, . . . , 707 and transceivers 500, . . . , 507). Some of the TNodes 802, 804, 806, 808 are (remote) WDs 806, 808.

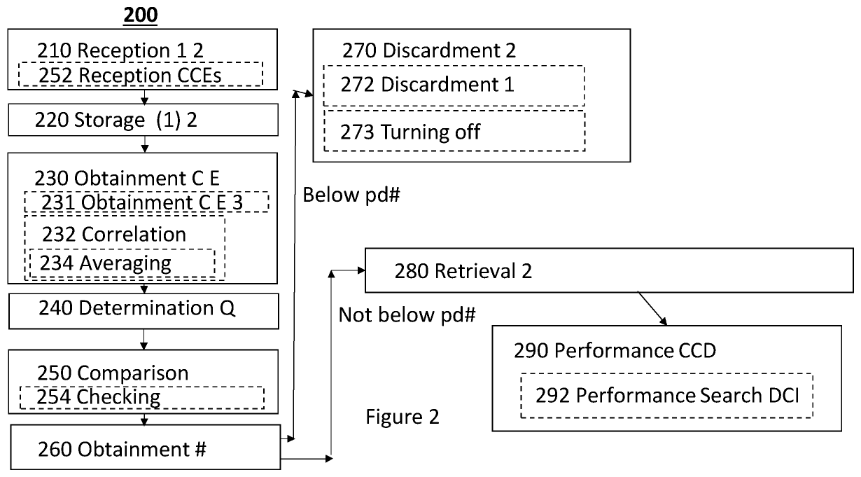

FIG. 2 illustrates actions/method steps implemented in a processing unit 600, such as a baseband (BB) processor, implemented in a wireless device (WD) 410 comprising the processing unit 600, or implemented in a control unit/control circuitry thereof, according to some embodiments. The processing unit 600 is comprised or comprisable in a WD 410. The WD 410 comprises one or more transceivers 500, 501, . . . , 507 and one or more memories 408. The one or more transceivers 500, 501, . . . , 507 and the one or more memories 408 are connected or connectable to the processing unit 600. Thus, the processing unit 600 is associated with the one or more memories 408. In some embodiments, the processing unit 600 is a baseband (BB) processor. In some embodiments, the processing unit 600 comprises a channel estimation unit. Furthermore, in some embodiments, the processing unit 600 comprises a control channel decoding unit. The processing unit 600 is or comprises controlling circuitry configured to cause reception 210 of a first and a second set of radio resources via the transceiver. To this end, the controlling circuitry may be associated with (e.g., operatively connectable, or connected, to) a first receiving unit (e.g., first receiving circuitry, first receiver or transceivers 500, 501, . . . , 507 with associated antenna units 700, 701, . . . , 707). Furthermore, in some embodiments, cause reception 210 comprises cause reception 252, at the WD 410, of a first number of control channel elements (CCEs) via the transceiver 500 or via one or more of the transceivers 500, 501, . . . , 507. Each CCE comprises a second number of Resource Element Groups (REGs). Furthermore, the first number of CCEs comprise a/the first and a/the second set of radio resources. Moreover, the first set of radio resources comprises, e.g., all, known reference symbols of/comprised in the first number of CCEs, and the second set of radio resources comprises, e.g., all, downlink control information (DCI) of/comprised in the first number of CCEs. Furthermore, the controlling circuitry causes or is configured to cause storage 220 of the second set of radio resources and optionally the first set of radio resources in the memory 408. To this end, the controlling circuitry may be associated with (e.g., operatively connectable, or connected, to) the memory 408 and a storing unit (e.g., storing circuitry, first storer or the processing unit 600). Moreover, the controlling circuitry causes or is configured to cause obtainment 230, 231 of one or more channel estimates, e.g., for a third number of REGs, based on the first set of radio resources. To this end, the controlling circuitry may be associated with (e.g., operatively connectable, or connected, to) a first obtainment unit (e.g., first obtaining circuitry, first obtainer, channel estimation unit, transceivers 500, 501, . . . , 507 with associated antenna units 700, 701, . . . , 707 or the processing unit 600). The controlling circuitry causes or is configured to cause determination 240 of a signal quality value for each of the one or more obtained channel estimates. To this end, the controlling circuitry may be associated with (e.g., operatively connectable, or connected, to) a first determining unit (e.g., first determining circuitry, first determiner or the processing unit 600). Furthermore, the controlling circuitry causes or is configured to cause comparison 250 of the one or more determined signal quality values to a quality threshold function. To this end, the controlling circuitry may be associated with (e.g., operatively connectable, or connected, to) a comparing unit (e.g., comparing circuitry, comparator, or the processing unit 600). Moreover, the controlling circuitry causes or is configured to cause obtainment 260 of a number of determined signal quality values being equal to or above the quality threshold function. To this end, the controlling circuitry may be associated with (e.g., operatively connectable, or connected, to) a second obtaining unit (e.g., second obtaining circuitry, second obtainer or the processing unit 600). If the obtained number of determined signal quality values is below a pre-determined number, the controlling circuitry causes or is configured to cause discarding 270 of the second set of radio resources from the memory 408 and optionally discarding 272 of the first set of radio resources from the memory 408 (if the first set of radio resources was stored in the memory 408). To this end, the controlling circuitry may be associated with (e.g., operatively connectable, or connected, to) a discarding unit (e.g., discarding circuitry, discarder, or the processing unit 600). In some embodiments, the controlling circuitry causes or is configured to cause turning off 273 of one or more transceivers 500, 501, . . . , 507, such as the transceiver 500, (and keeping the one or more transceivers 500, 501, . . . , 507, such as the transceiver 500, turned off until next time the WD needs to monitor for CORESETs, i.e., until the next/following time instant configured for CORESET monitoring (and turning the one or more transceivers 500, 501, . . . , 507 on at the next/following time instant configured for CORESET monitoring) if the obtained number of determined signal quality values is below a pre-determined number. To this end, the controlling circuitry may be associated with (e.g., operatively connectable, or connected, to) a controlling unit (e.g., additional controlling circuitry, or the processing unit 600). Alternatively, the one or more transceivers 500, 501, . . . , 507 are left on all the time (e.g., regardless of whether the obtained number of determined signal quality values is below a pre-determined number).

Furthermore, if the obtained number of determined signal quality values is equal to or above the pre-determined number the controlling circuitry causes or is configured to cause retrieval 280 of the second set of radio resources from the memory 408 and performance 290 of a control channel decoding of the second set of radio resources. To this end, the controlling circuitry may be associated with (e.g., operatively connectable, or connected, to) a retrieving unit (e.g., retrieving circuitry, retriever, or the processing unit 600) and/or a decoding unit (e.g., decoding circuitry, decoder, or the processing unit 600). In some embodiments, performance 290 of a control channel decoding of the second set of radio resources comprises performance 292 of a search for DCI in the second set of radio resources. To this end, the controlling circuitry may be associated with (e.g., operatively connectable, or connected, to) a searching unit (e.g., searching circuitry, searcher, researcher, or the processing unit 600).

In some embodiments, the controlling circuitry is configured to cause correlation 232, averaging 234 and/or checking 254 analogous to the steps 132, 134 described above and 154 described below. Furthermore, in some embodiments, one or more of the actions/implemented steps reception 210, storage 220, obtainment of channel estimates 230, correlation 232, averaging 234, determination 240, comparison 250, obtainment 260 of a number of determined signal quality values being equal to or above the quality threshold function, discardment 270 of second set, discardment 272 of first set 172, turning off 273, retrieval 280, performing 290control channel decoding and performing 292 a search for DCI are repeated. As an example, after step 270 or step 290 the method starts over again with the step 210 e.g., at the next/following time instant configured for CORESET monitoring, at which time instant the one or more transceivers 500, 501, . . . , 507 may be turned on.

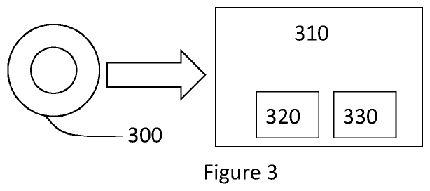

According to some embodiments, a computer program product comprising a non-transitory computer readable medium 300, such as a punch card, a compact disc (CD) ROM, a read only memory (ROM), a digital versatile disc (DVD), an embedded drive, a plug-in card, a random-access memory (RAM) or a universal serial bus (USB) memory, is provided. FIG. 3 illustrates an example computer readable medium in the form of a compact disc (CD) ROM 300. The computer readable medium has stored thereon, a computer program comprising program instructions. The computer program is loadable into a data processor (PROC) 320, which may, for example, be comprised in a computer 310 or a computing device, a processing unit, or a control unit. When loaded into the data processor, the computer program may be stored in a memory (MEM) 330 associated with or comprised in the data processor. According to some embodiments, the computer program may, when loaded into and run by the data processor, cause execution of method steps according to, for example, the method 100 illustrated in FIG. 1A, which is described herein. Furthermore, in some embodiments, there is provided a computer program product comprising instructions, which, when executed on at least one processor of a processing device, cause the processing device to carry out the method illustrated in FIG. 1A. Moreover, in some embodiments, there is provided a non-transitory computer-readable storage medium storing one or more programs configured to be executed by one or more processors of a processing device, the one or more programs comprising instructions which, when executed by the processing device, causes the processing device to carry out the method illustrated in FIG. 1A.

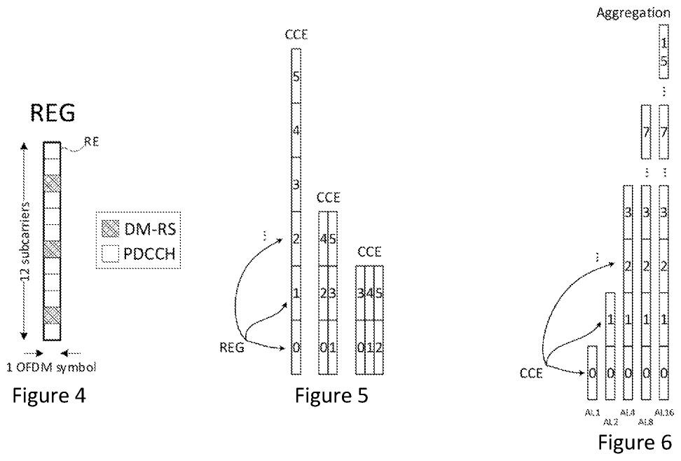

FIG. 4 illustrates a Resource Element Group (REG) according to some embodiments. A REG consists of 12 subcarriers in frequency domain (i.e., one Resource Block) and one orthogonal frequency-division multiplexing (OFDM) symbol in time domain. The REG comprises one or more reference signal(s), e.g., DM-RS(s), in predetermined positions/locations. Furthermore, in some embodiments, the REG comprises other data related to PDCCH. Such other data may be DCI.

FIG. 5 illustrates a control channel element (CCE) according to some embodiments. A CCE consists of 6 REGs. How the CCE is laid out in time and frequency depends on how wide the CORESET is, i.e., the number of OFDM symbols utilized. As an example, if the CORESET is one OFDM symbol wide (in the time domain), then the CCE consists of 6 REGs (72 subcarriers) in the frequency domain. As another example, if the CORESET is two OFDM symbols wide (in the time domain), then the CCE consists of 3 REGs per OFDM symbol (in the frequency domain). As yet another example, if the CORESET is three OFDM symbols wide (in the time domain), then the CCE consists of 2 REGs per OFDM symbol (in the frequency domain).

FIG. 6 illustrates an aggregation that constitutes a PDCCH comprising DCI according to some embodiments. How many CCEs an aggregation contains/comprises depends on the aggregation level (AL) used. Higher AL is used to obtain higher robustness and/or to be able to send DCI with more bits on the PDCCH. AL can be 1, 2, 4, 8 or 16.

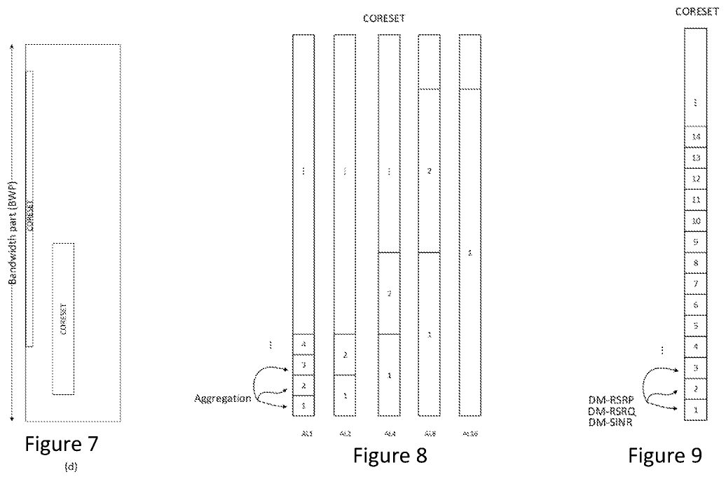

FIG. 7 illustrates two examples of a CORESET laid out in a slot or in a part of the total transmission bandwidth, i.e., a bandwidth part (BWP), according to some embodiments. In the first case, the CORESET is only one symbol wide. In the second case, the CORESET is 3 symbols wide. The CORESET may also be 2 symbols wide. A CORESET comprises one or more aggregations (depending on AL).

FIG. 8 illustrates possible positions for PDCCH in a CORESET according to some embodiments. The number of possible positions is controlled, among other things, by the AL used. The number of positions that need to be checked during detection also depends on how the WD has been configured by the network (and not only on how many positions are possible).

FIG. 9 illustrates how to estimate metrics of one or more reference signals, e.g., DM-RSs, over a number of subbands according to some embodiments. The estimated metrics may be one or more of Reference Signal Received Power (RSRP), Reference Signal Received Quality (RSRQ) and Signal to Interference & Noise Ratio (SINR). The estimation may be performed over a number of subbands that together cover a CORESET or a sufficiently large portion of a CORESET, where each subband can as an example correspond to the bandwidth of an aggregation with AL1. Alternatively, the estimation is performed over a subband corresponding to the lowest AL that the WD has been configured for by the network. This can be larger than AL1, e.g., AL2 or AL4. As another alternative, the WD 410 bases the measurement bandwidth on the current (e.g., a newly measured) signal-to-noise ratio and/or downlink control information (DCI) monitored by the WD (different formats have different numbers of bits and require different levels of AL).

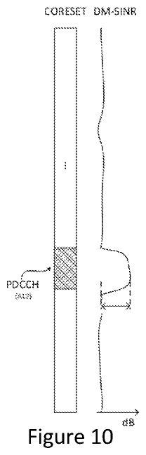

FIG. 10 illustrates an example of a PDCCH which has been transmitted/sent/received according to some embodiments. FIG. 10 shows an example where the PDCCH has been sent with AL2 in the 4th possible position, and where the SINR of the DM-RS indicates that in the fourth possible position, SINR is significantly better than in other parts of the CORESET.

Returning to FIG. 1A, in some embodiments, the step of comparing 150 the one or more determined signal quality values to a quality threshold function comprises: receiving 152, at the WD 410, a first number, such as 1, 2, 4, 8, or 16, of control channel elements (CCEs), each CCE comprising a second number, such as 6, of Resource Element Groups (REGs); and checking 154, e.g., by the processing unit 600, a third number, such as 2 or 3, of REGs to find out whether the signal quality of these REGs is higher than the threshold function. Alternatively, in some embodiments, the step of receiving 110 comprises receiving 152, at the WD 410, a first number, such as 1, 2, 4, 8, or 16, of CCEs, each CCE comprising a second number, such as 6, of REGs. The first number of CCEs comprise radio resources comprising known reference symbols, e.g., since one or more REGs of a CCE comprises one or more known reference symbols. Thus, a first number of CCEs comprises a, e.g., first, set of radio resources comprising known reference symbols. Furthermore, since at least some REGs comprise DCI, a first number of CCEs comprise a different, e.g., second, set of radio resources comprising DCI. In these embodiments, obtaining 130 comprises obtaining 131 one or more channel estimates for (e.g., only) a third number of REGs based on the first set of radio resources. In some embodiments, the third number is equal to or lower than the second number (e.g., if not every REG is compared to the threshold function). This may be the case if it is e.g., assumed that the first set of radio resources can only be present in the 2 or 3 first REGs of each CCE. Thus, in some embodiments, channel estimates for only a third number, lower/smaller than the second number, of REGs need to be obtained. However, in some embodiments, the third number is larger than the second number. As an example, the third number is 12 and the second number is 6. This may be the case if channel estimation is performed twice for each REG. Thus, in some embodiments, channel estimation is performed a plurality of times for each REG that is checked. I.e., in some embodiments, channel estimates for a third number, greater/larger than the second number, of REGs are obtained.

In some embodiments, the MATARA 420 comprises one or more chips. Furthermore, in some embodiments, one of the one or more chips comprises the processing unit 600.

### LIST OF EXAMPLES

Example 1. A method (100) of performing a control channel decoding, for a processing unit (600), wherein the processing unit (600) is comprisable in a wireless device, WD, (410), the WD (410) comprising a transceiver (500) and a memory (408) connectable to the processing unit (600), the method comprising:
   receiving (110) a first and a second set of radio resources via the transceiver (500);
   storing (120) the second set in the memory (408);
   obtaining (130) one or more channel estimates based on the first set of radio resources;
   determining (140) a signal quality value for the one or more obtained channel estimates;
   comparing (150) the one or more determined signal quality values to a quality threshold function;
   obtaining (160) a number of determined signal quality values being equal to or above the quality threshold function;
   if the obtained number of determined signal quality values is below a pre-determined number, discarding (170) the second set of radio resources from the memory (408); and
   if the obtained number of determined signal quality values is equal to or above the pre-determined number, retrieving (180) the second set of radio resources from the memory (408) and performing (190) a control channel decoding of the second set of radio resources.
Example 2. The method of example 1, wherein the first set of radio resources comprises known reference symbols, such as demodulation reference symbols, DM-RS, and the second set of radio resources comprises downlink control information, DCI.
Example 3. The method of any of examples 1-2, wherein performing (190) a control channel decoding of the second set of radio resources comprises performing (192) a search for DCI in the second set of radio resources.
Example 4. The method of any of examples 1-3, wherein obtaining (140) one or more channel estimates comprises correlating the first set of radio resources and individually known reference symbols to obtain one or more correlation metrics.
Example 5. The method of any of examples 1-4, wherein the quality threshold function is determined based on one or more obtained signal to noise ratio, SNR, values associated with a radio signal quality.
Example 6. The method of any of examples 1-5, wherein the quality threshold function is determined based on one or more reference signals, such as one or more synchronization signal blocks, SSBs, one or more Channel State Information Reference Signals, CSI-RSs, or demodulation reference signals, DM-RSs, retrieved from a successfully decoded DCI or from reference signals, such as demodulation reference signals, DM-RSs, associated with a data channel, such as a Physical Data Shared Channel, PDSCH.
Example 7. The method of any of examples 1-6, wherein the first and second sets of radio resources are received at time instants configured for control resource set, CORESET, monitoring.
Example 8. A computer program product comprising a non-transitory computer readable medium (200), having stored thereon a computer program comprising program instructions, the computer program being loadable into a data processing unit (320) and configured to cause execution of the method of any of examples 1-7 when the computer program is run by the data processing unit (320).
Example 9. A processing unit (600), such as a baseband, BB, processor, wherein the processing unit (600) is comprisable in a wireless device, WD, (410), the WD (410) comprising a transceiver (500) and a memory (408) connectable to the processing unit (600), the processing unit (600) comprising controlling circuitry configured to cause:
   reception (210) of a first and a second set of radio resources via the transceiver (500); storage (220) of the second set in the memory (408);
   obtainment (230) of one or more channel estimates based on the first set of radio resources;
   determination (240) of a signal quality value for each of the one or more obtained channel estimates;
   comparison (250) of the one or more determined signal quality values to a quality threshold function;
   obtainment (260) of a number of determined signal quality values being equal to or above the quality threshold function;
   if the obtained number of determined signal quality values is below a pre-determined number, discarding (270) of the second set of radio resources from the memory (408); and
   if the obtained number of determined signal quality values is equal to or above the pre-determined number, retrieval (280) of the second set of radio resources from the memory (408) and performance (290) of a control channel decoding of the second set of radio resources.
Example 10. The processing unit (600) of example 9, comprisable or comprised in the WD (410), wherein the processing unit (600) comprises a channel estimation unit and a control channel decoding unit, and wherein the processing unit (600) is connected to the transceiver (500) and the memory (408).

Generally, all terms used herein are to be interpreted according to their ordinary meaning in the relevant technical field, unless a different meaning is clearly given and/or is implied from the context in which it is used. Reference has been made herein to various embodiments. However, a person skilled in the art would recognize numerous variations to the described embodiments that would still fall within the scope of the claims. For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step. In the same manner, it should be noted that in the description of embodiments, the partition of functional blocks into particular units is by no means intended as limiting.

Contrarily, these partitions are merely examples. Functional blocks described herein as one unit may be split into two or more units. Furthermore, functional blocks described herein as being implemented as two or more units may be merged into fewer e.g., a single) unit. Any feature of any of the embodiments/aspects disclosed herein may be applied to any other embodiment/aspect, wherever suitable. Likewise, any advantage of any of the embodiments may apply to any other embodiments, and vice versa. Hence, it should be understood that the details of the described embodiments are merely examples brought forward for illustrative purposes, and that all variations that fall within the scope of the claims are intended to be embraced therein.

1. A method of performing a control channel decoding, for a processing unit, wherein the processing unit is comprisable in a wireless device, WD, the WD comprising a transceiver and a memory connectable to the processing unit, the method comprising:
receiving, at the WD, via the transceiver a first number of control channel elements, CCEs, each CCE comprising a second number of Resource Element Groups, REGs, the first number of CCEs comprising a first and a second set of radio resources,, wherein the first set of radio resources comprises known reference symbols of the first number of CCEs, and wherein the second set of radio resources comprises downlink control information, DCI of the first number of CCEs;
storing the second set of radio resources in the memory;
obtaining one or more channel estimates for a third number of REGs based on the first set of radio resources, wherein the third number is larger than or smaller than the second number;
determining a signal quality value for each of the one or more obtained channel estimates;
comparing the one or more determined signal quality values to a quality threshold function;
obtaining a number of determined signal quality values being equal to or above the quality threshold function;
if the obtained number of determined signal quality values is below a pre-determined number, discarding the second set of radio resources from the memory; and
if the obtained number of determined signal quality values is equal to or above the pre-determined number, retrieving the second set of radio resources from the memory and performing a control channel decoding of the second set of radio resources.

2-3. (canceled)

4. The method of claim 1, wherein the first set of radio resources comprises all known reference symbols comprised by the first number of CCEs, and wherein the second set of radio resources comprises all DCI comprised by the first number of CCEs.

5. The method of claim 1, wherein performing a control channel decoding of the second set of radio resources comprises performing a search for DCI in the second set of radio resources.

6. The method of claim 1, wherein obtaining one or more channel estimates comprises correlating the first set of radio resources and individually known reference symbols to obtain one or more correlation metrics, and wherein the correlating comprises averaging over the previous reference symbol, the current reference symbol, and the following reference symbol.

7. The method of claim 1, wherein the quality threshold function is determined based on one or more obtained signal to noise ratio, SNR, values associated with a radio signal quality, and wherein the quality threshold function comprises a corresponding value for each of the determined signal quality values.

8. The method of claim 1, wherein the quality threshold function is determined based on one or more synchronization signal blocks retrieved from a successfully decoded DCI or one or more Channel State Information Reference Signals, retrieved from a successfully decoded DCI.

9. The method of claim 1 wherein the first and second sets of radio resources are received at time instants configured for control resource set, CORESET, monitoring.

10. (canceled)

11. A non-transitory computer-readable storage medium storing one or more programs configured to be executed by one or more processors of a processing device, the one or more programs comprising instructions which, when executed by the processing device, causes the processing device to carry out the method according to claim 1.

12. A processing unit, such as a baseband, BB, processor, wherein the processing unit is comprisable in a wireless device, WD, the WD comprising a transceiver and a memory connectable to the processing unit, the processing unit comprising controlling circuitry configured to cause:
reception, at the WD, via the transceiver, of a first number of control channel elements, CCEs, each CCE comprising a second number of Resource Element Groups, REGs, and the first number of CCEs comprising a first and a second set of radio resources, wherein the first set of radio resources comprises known reference symbols of the first number of CCEs, and wherein the second set of radio resources comprises downlink control information, DCI, of the first number of CCEs;
storage of the second set of radio resources in the memory;
obtainment of one or more channel estimates for a third number of REGs based on the first set of radio resources, wherein the third number is smaller than or larger than the second number;
determination of a signal quality value for each of the one or more obtained channel estimates;
comparison of the one or more determined signal quality values to a quality threshold function;
obtainment of a number of determined signal quality values being equal to or above the quality threshold function;
if the obtained number of determined signal quality values is below a pre-determined number, discarding of the second set of radio resources from the memory; and
if the obtained number of determined signal quality values is equal to or above the pre-determined number, retrieval of the second set of radio resources from the memory and performance of a control channel decoding of the second set of radio resources.

13. The processing unit of claim 12, comprisable or comprised in the WD, wherein the processing unit comprises a channel estimation unit and a control channel decoding unit, and wherein the processing unit is connected to the transceiver and the memory.

14-15. (canceled)

16. The processing unit of claim 12, wherein the third number is lower than the second number.

17. The processing unit of claim 12, wherein the first set of radio resources comprises all known reference symbols comprised by the first number of CCEs, and wherein the second set of radio resources comprises all DCI comprised by the first number of CCEs.

18. (canceled)

19. The method of claim 1, wherein the quality threshold function is determined based on one or more demodulation reference signals retrieved from a successfully decoded DCI.

20. The method of claim 1, wherein the quality threshold function is determined based on reference signals associated with a Physical Data Shared Channel (PDSCH).

21. The method of claim 20, wherein the reference signals are demodulation reference signals.

22. The method of claim 1, wherein channel estimates are only obtained for each of the two or three first REGs of each CCE, and wherein the third number is smaller than the second number.

23. The method of claim 1, wherein two channel estimates are obtained for each REG, and wherein the third number is larger than the second number.
